(19) United States
(12) Patent Application Publication
(10) Pub. No.: US 2006/0158782 A1
(43) Pub. Date: Jul. 20, 2006

(54) Magnetic head support, magnetic head assembly including the magnetic head support, and magnetic disk drive including the magnetic head assembly

(75) Inventors: Kousaku Wakatsuki, Kanagawa (JP); Shigeo Nakamura, Kanagawa (JP); Hiroshi Agari, Kanagawa-ken (JP); Haruhide Takahashi, Kanagawa-ken (JP)

Correspondence Address: TOWNSEND AND TOWNSEND AND CREW LLP, TWO EMBARCADERO CENTER, 8TH FLOOR, SAN FRANCISCO, CA, 94111, US

(73) Assignee: Hitachi Global Storage Technologies Netherlands B.V., Amsterdam (NL)

(21) Appl. No.: 11/326,612

(22) Filed: Jan. 4, 2006

(30) Foreign Application Priority Data
Jan. 4, 2005 (JP) 2005-000270

(51) Int. Cl. G11B 5/48

(52) U.S. Cl. 360/244.2

(57) ABSTRACT

Embodiments of the invention provide a magnetic head support capable of achieving reduction in weight, while maintaining good stiffness and vibration characteristics, a magnetic head assembly including the magnetic head support, and a magnetic disk drive including the magnetic head assembly. In one embodiment, the magnetic head support includes (a) an arm pivotally supported, (b) a load beam secured to the arm, and (c) a flexure secured to the load beam. The load beam (b) includes (b-1) a spring portion and (b-2) a leading end portion. The leading end portion (b-2) includes an elongated portion having a width smaller than an external dimension of the spring portion and having leading end flanges on both edges thereof and a base portion for connecting the elongated portion and the spring portion. The flexure (c) includes a backing member with which the base portion is backed. The magnetic head assembly includes the magnetic head support, and the magnetic disk drive includes the magnetic head assembly.

### CROSS-REFERENCES TO RELATED APPLICATIONS

This application claims priority from Japanese Patent Application No. JP2005-000270, filed Jan. 4, 2005, the entire disclosure of which is incorporated herein by reference.

### BACKGROUND OF THE INVENTION

The present invention relates to a magnetic head support used when information is written on a magnetic disk medium or a related task is performed. More specifically, the present invention relates to reduction in weight of the magnetic head support.

A magnetic disk drive, such as a hard disk drive or the like, includes a magnetic disk medium 500 and a magnetic head assembly 502 as shown, for example, in FIG. 22. Referring to FIG. 22, the magnetic disk medium 500 is rotatably held in position. The magnetic head assembly 502 is pivotally supported by a pivot shaft 501, and includes a magnetic head that writes information to the magnetic disk medium 500 and performs related tasks.

The magnetic disk drive, such as that described above, is used not only in computers, but also, for example, in portable music players and the like. The magnetic disk drive is herein required to offer high-shock properties that ensures that the magnetic disk drive can operate even when vibration or shock is applied thereto as a result of the music player being dropped or the like.

To enhance the high-shock properties of the magnetic disk drive, therefore, an attempt is made, for example, to reduce the weight of the magnetic head assembly 502.

An attempt to reduce the weight of the magnetic head support will be described using a magnetic head assembly shown in FIGS. 23 through 26 as an exemplary case. FIG. 23 is a plan view showing the magnetic head assembly as viewed from a side facing the magnetic disk medium. FIG. 24 is a plan view showing the magnetic head assembly as viewed from a side opposite to that of FIG. 23. FIG. 25 is a side elevational view showing the magnetic head assembly. FIG. 26 is a cross sectional view taken along line x-x of FIG. 24.

The magnetic head assembly includes an arm 602, a load beam 603, a flexure 604, and a head slider 605. The arm 602 is pivotally held by a pivot shaft 601. The load beam 603 is secured to the arm 602. The flexure 604 is secured to the load beam 603. The head slider 605 is secured to a portion near a tip of the flexure 604. It should be noted that the magnetic head assembly excluding the head slider 605 is referred to as the magnetic head support.

The load beam 603 includes a spring portion 610 and a tapered end portion 620. The spring portion 610 functions as a spring when a part thereof flexes (see FIG. 25) to press the head slider 605 toward the magnetic disk medium (not shown). The tapered end portion 620 extends forward from the spring portion 610 and is shaped into a taper on both sides, each tapered portion defining a predetermined angle γ relative to a center line Q in the longitudinal direction of the load beam 603.

The load beam 603 weighs relatively heavily among other members constituting the magnetic head support. Reduction in weight can therefore be achieved by reducing the thickness and width of the load beam 603.

Reduction in thickness and width of the load beam 603, however, results in stiffness thereof being also decreased. This could result in the increased amplitude of vibration during a seek operation, which may make it difficult to position the head slider 605 at a desired track, or would present other problems.

Stiffness of the load beam 603 can be maintained and vibration inhibited by, for example, forming a straight flange 621 having a substantially L-shaped cross section (see FIG. 26) (for example, Patent Document 1 (Japanese Patent Laid-open No. 2000-40319) over substantially an entire area on both edges of the tapered end portion 620.

### BRIEF SUMMARY OF THE INVENTION

However, if the aforementioned load beam 603 is demanded for reduction in width thereof, for example, then the width of the spring portion 610 will also be reduced inevitably. In this case, it will be difficult to maintain good stiffness and vibration characteristics of the load beam 603, since it becomes impossible to ensure spring characteristics required of the spring portion 610.

It is therefore a feature of the present invention to provide a magnetic head support capable of achieving reduction in weight, while maintaining good stiffness and vibration characteristics. It is a feature of the present invention to provide a magnetic head assembly including the magnetic head support, and a magnetic disk drive including the magnetic head assembly.

To solve the foregoing problem of the prior art, a magnetic head support according to one embodiment of the present invention includes:

(a) an arm pivotally supported;

(b) a load beam secured to the arm, the load beam including:
(b-1) a spring portion; and
b-2) a leading end portion including an elongated portion having a width smaller than an external dimension of the spring portion and having leading end flanges on both edges thereof and a base portion for connecting the elongated portion and the spring portion; and

(c) a flexure secured to the load beam, the flexure including a backing member with which the base portion is backed.

A magnetic head support according to another embodiment of the present invention includes:

(a) an arm pivotally supported;

(b) a load beam secured to the arm, the load beam including:
(b-1) a spring portion; and
(b-2) a leading end portion including an elongated portion having a width smaller than an external dimension of the spring portion and having leading end flanges on both edges thereof and a base portion for connecting the elongated portion and the spring portion;

(c) a flexure secured to the load beam; and

(d) reinforcement flanges formed on the load beam and/or the flexure to extend over an area from the elongated portion to the base portion at a position, in which a part of the reinforcement flanges overlaps the leading end flanges in a width direction of the load beam.

A magnetic head support according to still another embodiment of the present invention includes:

(a) an arm pivotally supported; and

(b) a load beam secured to the arm, the load beam including:
(b-1) a spring portion; and
(b-2) a leading end portion including an elongated portion having a width smaller than an external dimension of the spring portion and having leading end flanges on both edges thereof and a base portion for connecting the elongated portion and the spring portion, and flanges formed from both edges of the elongated portion to both edges of the base portion.

### BRIEF DESCRIPTION OF THE DRAWINGS

FIG. 1 is a bottom plan view showing a magnetic head assembly according to a first aspect of an embodiment of the present invention.

FIG. 2 is a top plan view showing the magnetic head assembly according to the first aspect of the embodiment of the present invention.

FIG. 3 is a side elevational view showing the magnetic head assembly according to the first aspect of the embodiment of the present invention.

FIG. 4 is a cross sectional view taken along line a-a of FIG. 2.

FIG. 5 is a bottom plan view showing a magnetic head assembly according to a second aspect of an embodiment of the present invention.

FIG. 6 is a top plan view showing the magnetic head assembly according to the second aspect of the embodiment of the present invention.

FIG. 7 is a side elevational view showing the magnetic head assembly according to the second aspect of the embodiment of the present invention.

FIG. 8 is a cross sectional view taken along line b-b of FIG. 6.

FIG. 9 is a bottom plan view showing a magnetic head assembly according to a third aspect of an embodiment of the present invention.

FIG. 10 is a top plan view showing the magnetic head assembly according to the third aspect of the embodiment of the present invention.

FIG. 11 is a side elevational view showing the magnetic head assembly according to the third aspect of the embodiment of the present invention.

FIG. 12 is a cross sectional view taken along line c-c of FIG. 10.

FIG. 13 is a bottom plan view showing a magnetic head assembly according to a fourth aspect of an embodiment of the present invention.

FIG. 14 is a top plan view showing the magnetic head assembly according to the fourth aspect of the embodiment of the present invention.

FIG. 15 is a side elevational view showing the magnetic head assembly according to the fourth aspect of the embodiment of the present invention.

FIG. 16 is a cross sectional view taken along line d-d of FIG. 14.

FIG. 17 is a bottom plan view showing a magnetic head assembly according to a fifth aspect of an embodiment of the present invention.

FIG. 18 is a top plan view showing the magnetic head assembly according to the fifth aspect of the embodiment of the present invention.

FIG. 19 is a side elevational view showing the magnetic head assembly according to the fifth aspect of the embodiment of the present invention.

FIG. 20 is a cross sectional view taken along line e-e of FIG. 18.

FIG. 21 is a chart showing results of an analysis made of eigen values using finite element method for the magnetic head assembly according to the embodiment of the present invention.

FIG. 22 is a perspective view showing a typical magnetic disk drive.

FIG. 23 is a bottom plan view showing a typical magnetic head assembly.

FIG. 24 is a top plan view showing a typical magnetic head assembly.

FIG. 25 is a side elevational view showing a typical magnetic head assembly.

FIG. 26 is a cross sectional view taken along line x-x of FIG. 24.

### DETAILED DESCRIPTION OF THE INVENTION

A magnetic head support (hereinafter referred to as the support) and a magnetic head assembly (hereinafter referred to as the assembly) according to an exemplary embodiment of the present invention will be described with reference to the accompanying drawings.

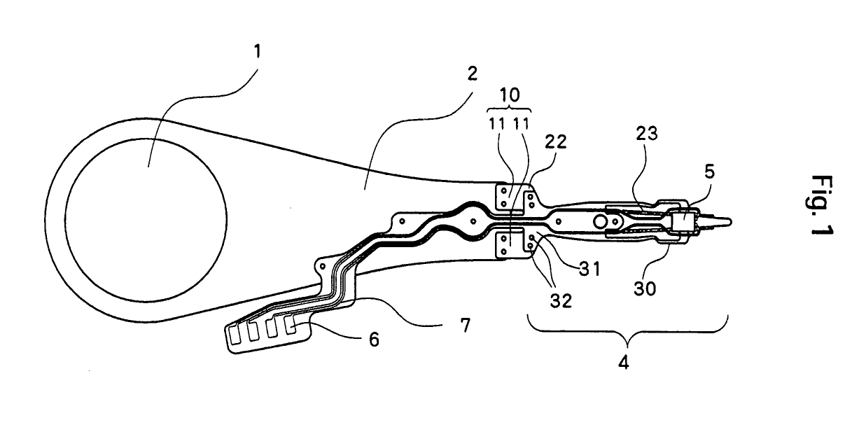

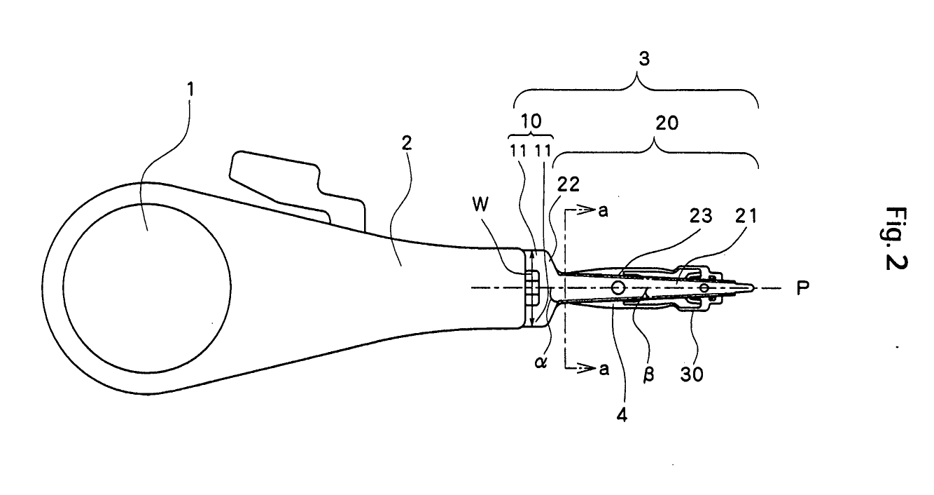

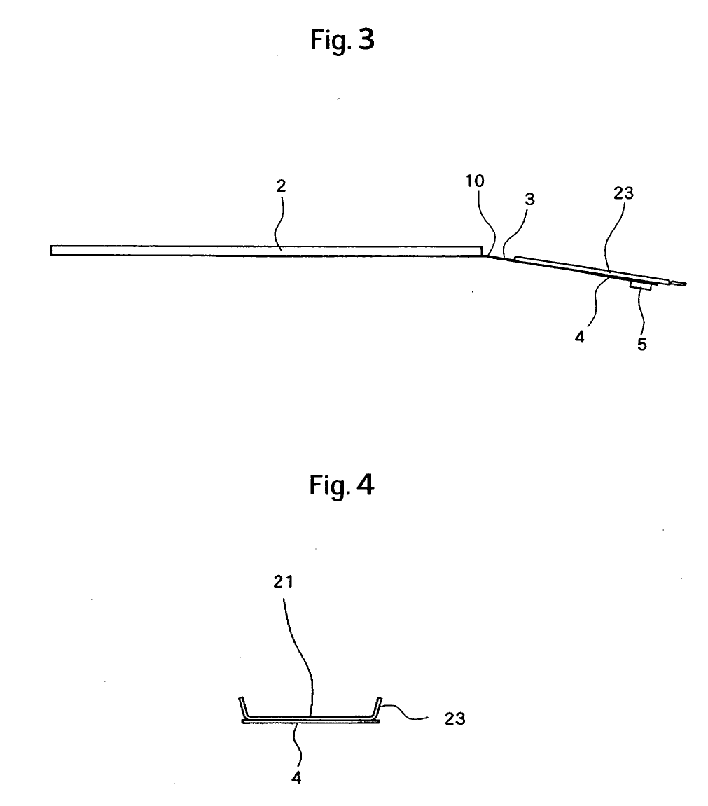

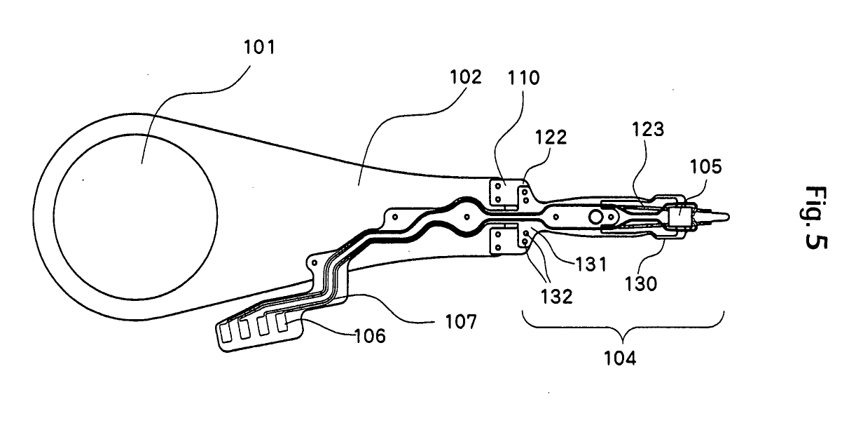

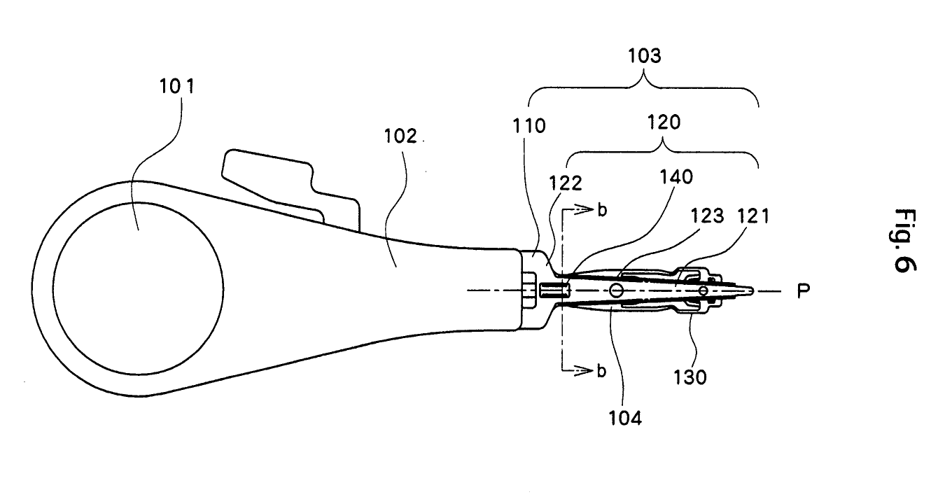

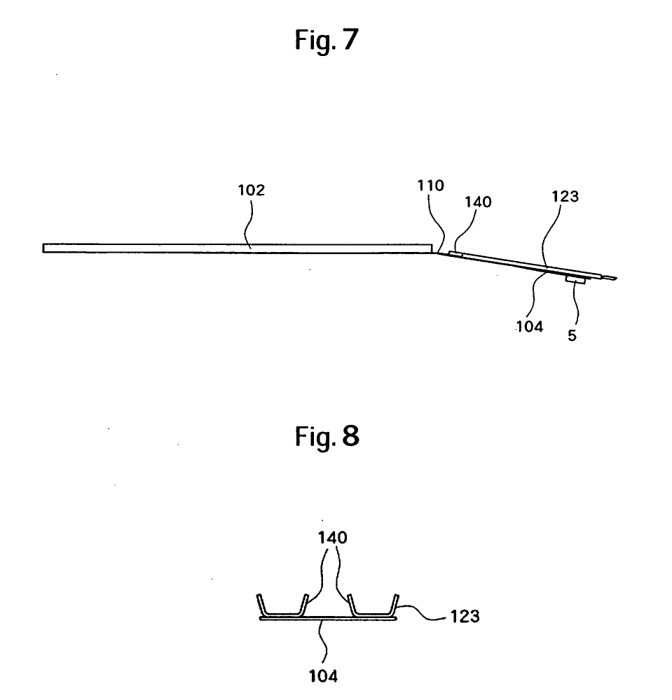

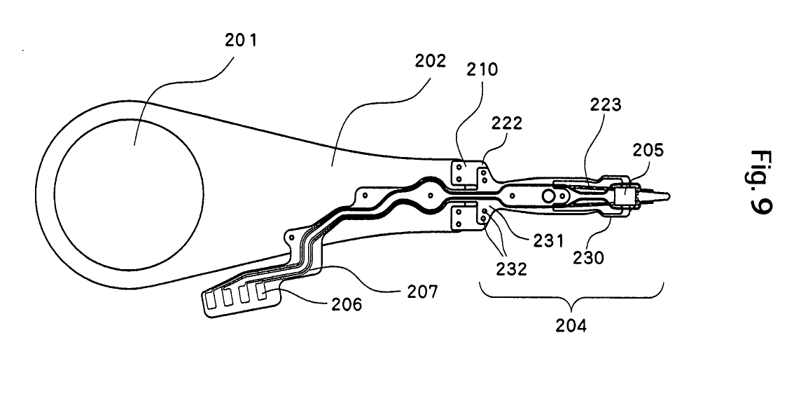

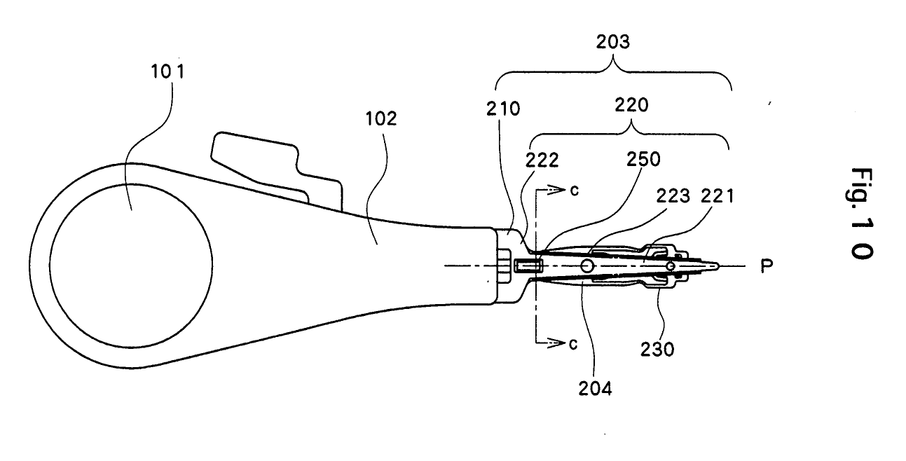

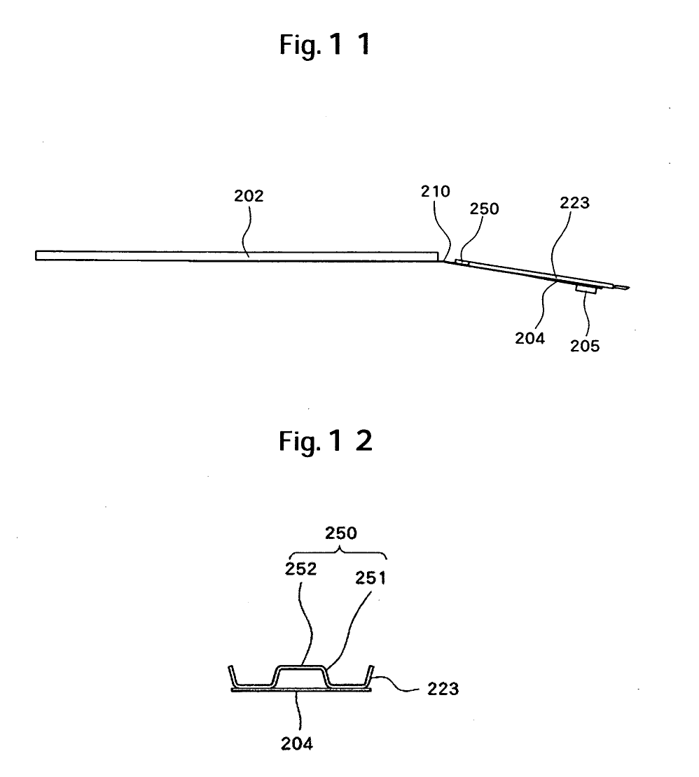

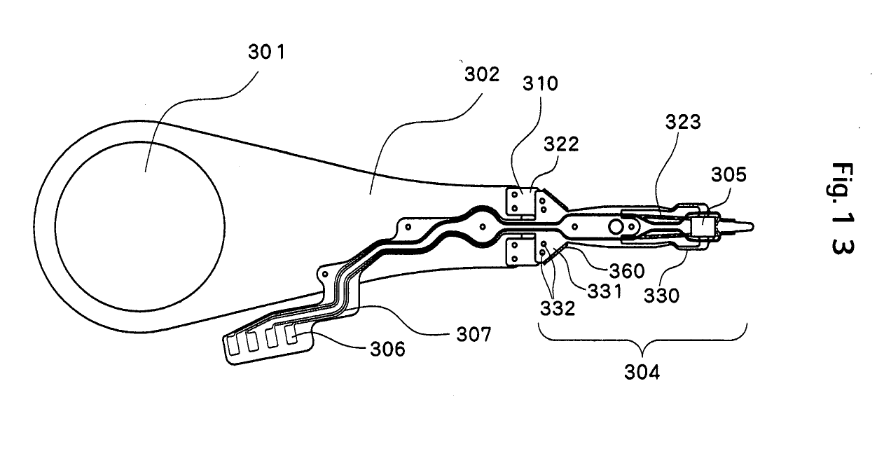

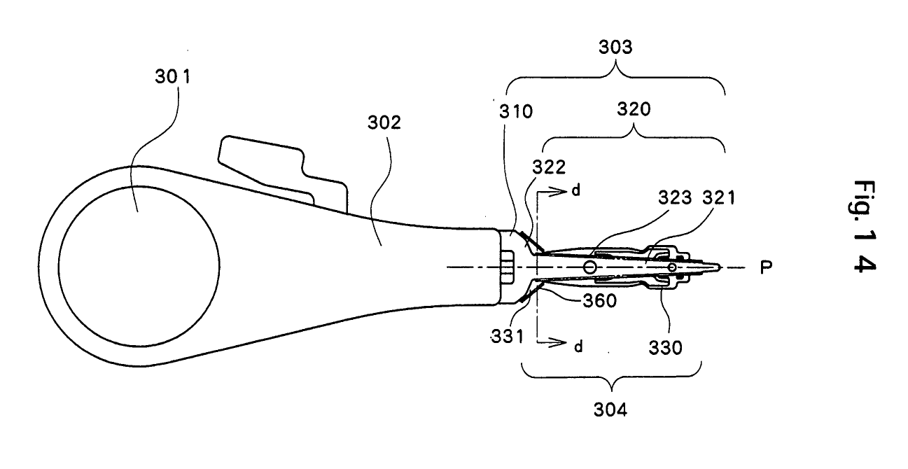

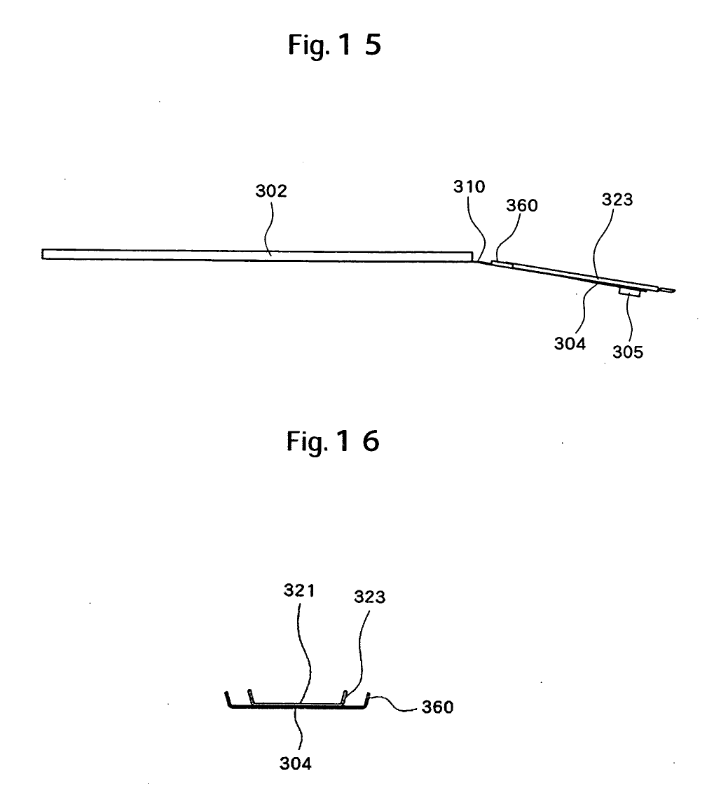

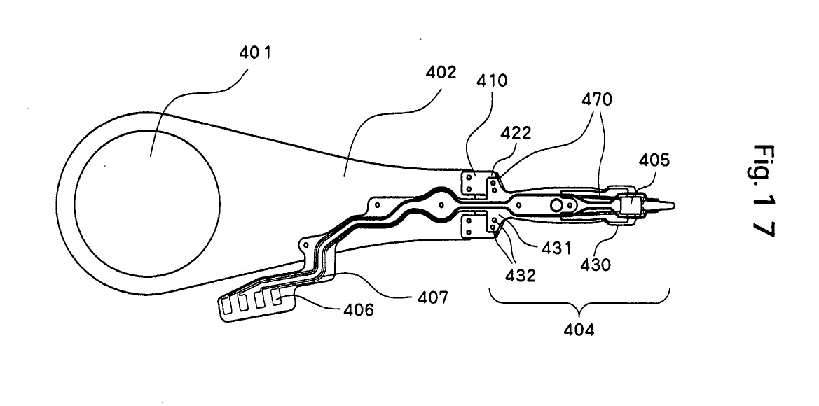

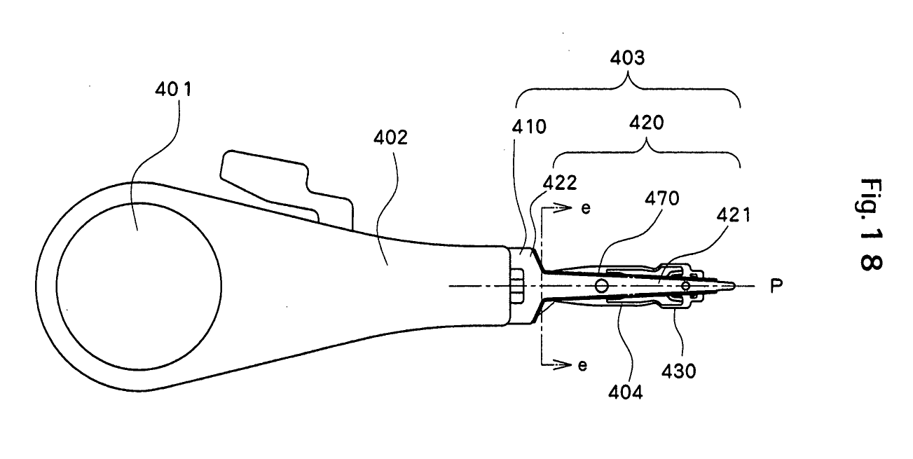

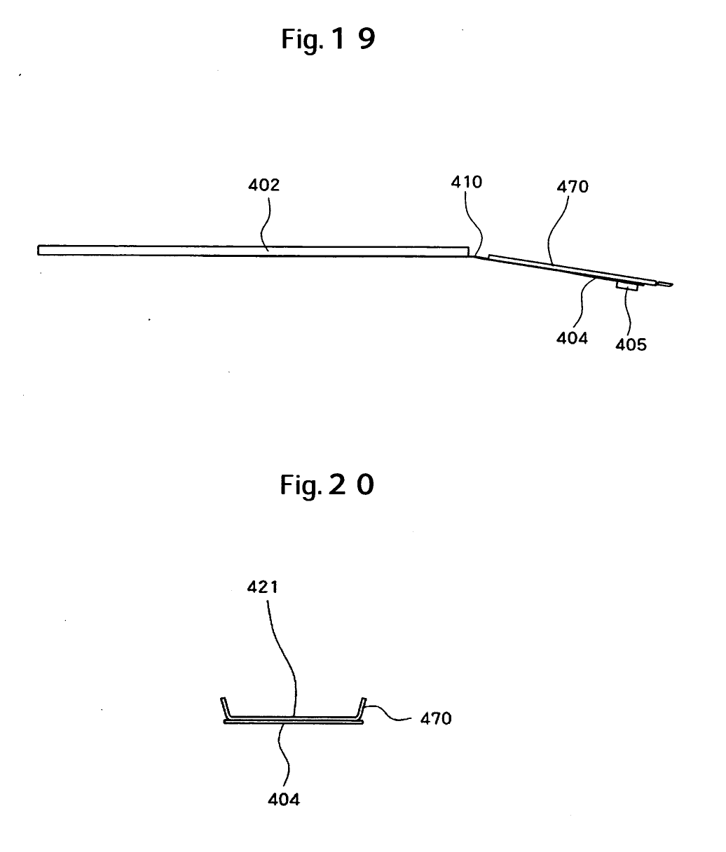

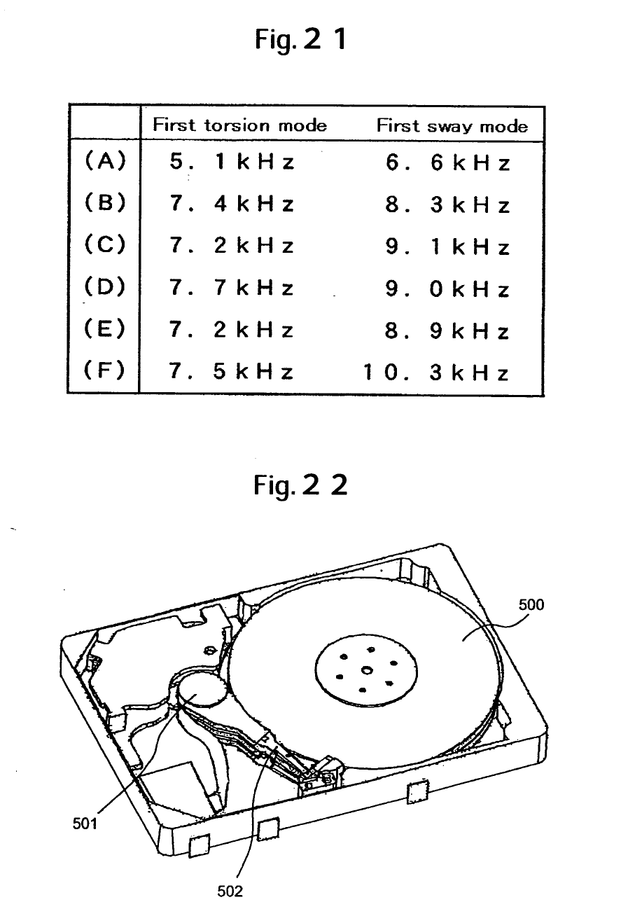

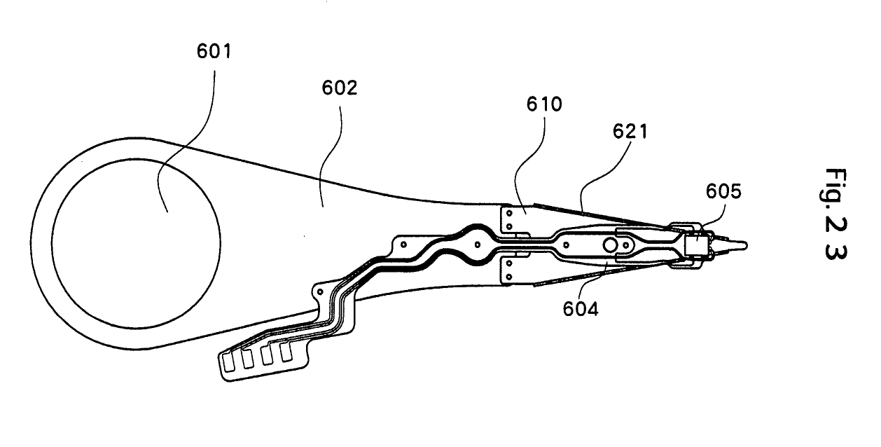

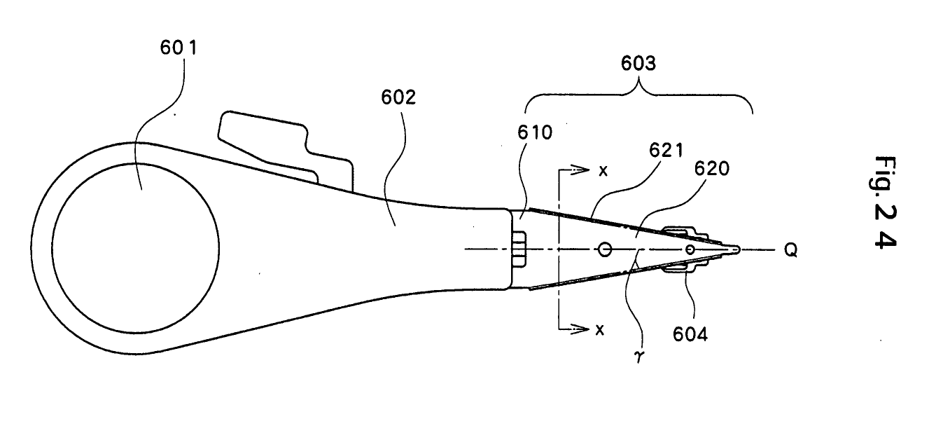

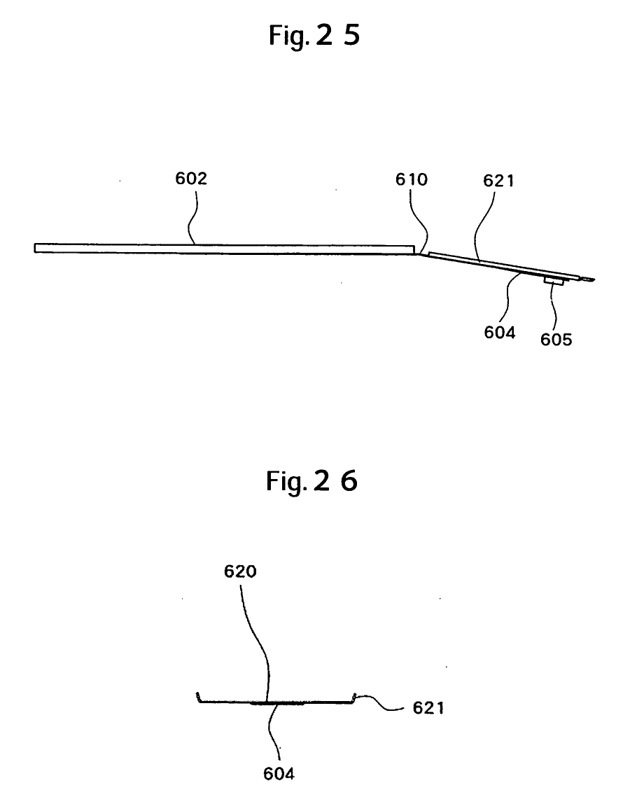

The assembly according to a first aspect of the present invention is shown in FIGS. 1 through 4. FIG. 1 is a plan view showing the assembly that is the support mounted with a head slider, as viewed from a side facing the magnetic disk medium (hereinafter referred to as the lower surface side). FIG. 2 is a plan view showing the assembly as viewed from a side (hereinafter referred to as the upper surface side) opposite to that of FIG. 1. FIG. 3 is a side elevational view showing the assembly. FIG. 4 is a cross sectional view taken along line a-a of FIG. 2. For convenience sake, FIG. 3 shows a condition, in which the assembly is yet to be disposed in opposition to the magnetic disk medium.

According to the first aspect of the present invention, the assembly includes an arm 2, a load beam 3, a flexure 4, and a head slider 5. The arm 2 is pivotally held by a pivot shaft 1. The load beam 3 is secured to a portion close to a front end of the arm 2 on the lower surface side thereof. The flexure 4 is secured to the lower surface side of the load beam 3. The head slider 5 is secured to a portion near a tip of the flexure 4 on the lower surface side thereof. The head slider 5 includes a magnetic head.

The load beam 3 includes a spring portion 10 and a leading end portion 20. A trailing end of the spring portion 10 is secured to the arm 2 through welding, caulking, or the like. The leading end portion 20 extends forward from the spring portion 10.

The spring portion 10 is provided with a through hole of a substantially rectangular shape near a centerline P in the longitudinal direction of the load beam 3. Further, the spring portion 10 is formed with a pair of spring portion pieces 11 so as to oppose to each other across the through hole. A part of the spring portion 10 is bent (see FIG. 3). A portion of the load beam 3 on the side of a leading end (including the leading end portion 20) from the bent portion is inclined. A spring load for pressing the head slider 5 toward the side of a magnetic disk not shown is generated through elasticity of the load beam 3 thereby developing.

The leading end portion 20 includes an elongated portion 21 and a base portion 22. The elongated portion 21 extends slenderly forwardly, having a width narrower than an external dimension W of the spring portion 10 (that is, the distance between both ends of the load beam 3 in a direction perpendicular to the centerline P in the longitudinal direction of the load beam 3, or the width of the spring portion 10). The base portion 22 connects the elongated portion 21 with the spring portion 10.

The elongated portion 21 includes substantially straight flanges (hereinafter referred to as leading end flanges 23) on both edges in the longitudinal direction. The leading end flanges 23 are formed, for example, as follows. Specifically, referring to FIG. 4, parts of both edges of the elongated portion 21 are bent upwardly to be substantially L-shaped at line a-a that traverses in a width direction of the elongated portion 21 near a trailing end thereof. Stiffness of the elongated portion 21 is thereby enhanced.

The base portion 22 is formed into a taper such that the width thereof sharply decreases toward the elongated portion 21 from the spring portion 10 so as to compensate for a great difference in width between a front end of the spring portion 10 and a rear end of the elongated portion 21.

A taper angle α defined between either of both ends of the base portion 22 and the centerline P in the longitudinal direction is greater than a taper angle β defined between either of both ends of the elongated portion 21 and the centerline P.

As such, both ends of the base portion 22 do not exist along extension lines of both ends of the elongated portion 21. Accordingly, it is not necessarily easy to form flanges contiguous with the leading end flanges 23 on both ends of the base portion 22. According to the first aspect of the present invention, therefore, stiffness of the base portion 22 is enhanced by using part of the flexure 4 to be described in the following, instead of forming flanges in the base portion 22.

Specifically, the flexure 4 of the support includes a flexible portion 30 and a backing member 31. The flexible portion 30 has flexibility and the head slider 5 is secured thereto. The backing member 31 is secured to the base portion 22 of the load beam 3. A wire pattern 7 is disposed via an insulating layer (e.g., polyimide, or the like) on the lower surface of the flexure 4 near a center thereof in the longitudinal direction. The wire pattern 7 connects the magnetic head of the head slider 5 with a terminal portion 6.

The backing member 31 of the flexure 4 is formed to have a greater width than the trailing end of the elongated portion 21 of the load beam 3 does. More specifically, the backing member 31 is formed into a taper, both ends of which run along both edges of the base portion 22 so as to cover a substantially entire portion of the base portion 22 from the lower surface side. Specifically, the backing member 31 is formed into a wide wing shape having a greater width than the trailing end of the elongated portion 21 but a smaller width than the front end of the spring portion 10.

The backing member 31 is secured to the lower surface side of the base portion 22 through welding, caulking, or the like at fixing points 32 in both wings sandwiching the wire pattern 7 disposed in the flexure 4. As such, the base portion 22 is backed with the backing member 31 to achieve an enhanced stiffness thereof.

The assembly according to a second aspect of the present invention is shown in FIGS. 5 through 8. FIG. 5 is a view showing the lower surface of the assembly. FIG. 6 is a view showing the upper surface of the assembly. FIG. 7 is a side elevational view showing the assembly. FIG. 8 is a cross sectional view taken along line b-b of FIG. 6. In the assembly according to the second aspect of the present invention, like parts as those used in the assembly according to the first aspect of the present invention are identified by the same reference numbers plus 100, and detailed descriptions for the same will be omitted.

In the assembly according to the second aspect of the present invention, a load beam 103 of the support includes a pair of reinforcement flanges 140. The pair of reinforcement flanges 140 is formed at a portion near a centerline P in the longitudinal direction of a leading end portion 120 so as to cover an area from a portion near a trailing end of an elongated portion 121 to a base portion 122.

The reinforcement flanges 140 are formed at a position, in which a part of the reinforcement flanges 140 overlaps leading end flanges 123 in a width direction of the load beam 103. For example, referring to FIG. 8, the reinforcement flanges 140 are formed between the pair of leading end flanges 123 formed on both edges of the elongated portion 121 at line b-b that traverses in a width direction of the elongated portion 121 near the trailing end thereof.

More specifically, referring to FIG. 7, the load beam 103 includes the leading end flanges 123 that extend over an area from a portion near the leading end of the elongated portion 121 to the trailing end thereof, of an inclined portion forward from a bent portion of a spring portion 110. In addition, the load beam 103 includes the reinforcement flanges 140 that extend from the position, at which the part of the reinforcement flanges 140 overlaps the leading end flanges 123 to the base portion 122.

As described in the foregoing, in the load beam 103 according to the second aspect of the present invention, the reinforcement flanges 140 are disposed in the area from the portion near the trailing end of the elongated portion 121 to the base portion 122, where a taper angle of the leading end portion 120 varies. Stiffness of the load beam 103 is thereby enhanced. If such reinforcement flanges 140 are provided, a flexure 104 may not include a backing member 131.

The assembly according to a third aspect of the present invention is shown in FIGS. 9 through 12. FIG. 9 is a view showing the lower surface of the assembly. FIG. 10 is a view showing the upper surface of the assembly. FIG. 11 is a side elevational view showing the assembly. FIG. 12 is a cross sectional view taken along line c-c of FIG. 10. In the assembly according to the third aspect of the present invention, like parts as those used in the assembly according to the first aspect of the present invention are identified by the same reference numbers plus 200, and detailed descriptions for the same will be omitted.

In the assembly according to the third aspect of the present invention, a load beam 203 of the support includes a reinforcement flange structure 250. The reinforcement flange structure 250 is formed at a portion near a centerline P in the longitudinal direction of a leading end portion 220 so as to cover an area from an elongated portion 221 to a base portion 222.

The reinforcement flange structure 250 is formed at a position, in which a part of the reinforcement flange structure 250 overlaps leading end flanges 221 in a width direction of the load beam 203. For example, referring to FIG. 12, the reinforcement flange structure 250 is formed between the pair of leading end flanges 223 formed on both edges of the elongated portion 221 at line c-c that traverses in a width direction of the elongated portion 221 near the trailing end thereof.

Referring to FIG. 12, the reinforcement flange structure 250 is formed to include a pair of flange side surfaces 251 formed near the centerline P in the longitudinal direction of the load beam 203 and a ceiling surface 252 for connecting upward the two flange side surfaces 251. The reinforcement flange structure 250 can be formed through drawing or the like.

More specifically, referring to FIG. 11, the load beam 203 includes the leading end flanges 223 that extend over an area from a portion near the leading end of the elongated portion 221 to the trailing end thereof, of an inclined portion forward from a bent portion of a spring portion 210. In addition, the load beam 203 includes the reinforcement flange structure 250 that extends from the position, at which the part of the reinforcement flange structure 250 overlaps the leading end flanges 223 to the base portion 222.

As described in the foregoing, in the load beam 203 according to the third aspect of the present invention, the reinforcement flange structure 250 is disposed in the area from the portion near the trailing end of the elongated portion 221 to the base portion, where a taper angle of the leading end portion 220 varies. Stiffness of the load beam 203 is thereby enhanced. If such a reinforcement flange structure 250 is provided, a flexure 204 may not include a backing member 231.

The assembly according to a fourth aspect of the present invention is shown in FIGS. 13 through 16. FIG. 13 is a view showing the lower surface of the assembly. FIG. 14 is a view showing the upper surface of the assembly. FIG. 15 is a side elevational view showing the assembly. FIG. 16 is a cross sectional view taken along line d-d of FIG. 14. In the assembly according to the fourth aspect of the present invention, like parts as those used in the assembly according to the first aspect of the present invention are identified by the same reference numbers plus 300, and detailed descriptions for the same will be omitted.

In the assembly according to the fourth aspect of the present invention, a backing member 331 of a flexure 304 is formed into a taper, the width of which increases linearly from a portion near a trailing end of an elongated portion 321 toward a portion near a trailing end of a base portion 322. A straight reinforcement flange 360 is placed in each of both edges of the taper.

The reinforcement flanges 360 are formed at a position, in which a part of the reinforcement flanges 360 overlaps leading end flanges 323 in a width direction of the load beam 303. For example, referring to FIG. 16, the reinforcement flanges 360 are formed so as to sandwich the pair of leading end flanges 323 formed on both edges of the elongated portion 321 at line d-d that traverses in a width direction of the elongated portion 321 near the trailing end thereof. The reinforcement flanges 360 are formed into substantially an L-shape in which each of both edges of the backing member 331 is upwardly bent.

More specifically, referring to FIG. 15, the support includes the leading end flanges 323 that extend over an area from a portion near the leading end of the elongated portion 321 to the trailing end thereof, in a range of an inclined portion forward from a bent portion of a spring portion 310 of the load beam 303. In addition, the support includes the reinforcement flanges 360 on the backing member 331 of the flexure 304. The reinforcement flanges 360 extend from the position near the trailing end of the elongated portion 321, at which the part of the reinforcement flanges 360 overlaps the leading end flanges 323 to the base portion 322.

As described in the foregoing, in the assembly according to the fourth aspect of the present invention, the reinforcement flanges 360 are disposed on the backing member 331, with which a portion of a leading end portion 320 with varying taper angles is backed, in the area from the portion near the trailing end of the elongated portion 321 to the base portion 322. Stiffness of the load beam 303 is thereby enhanced.

The assembly according to a fifth aspect of the present invention is shown in FIGS. 17 through 20. FIG. 17 is a view showing the lower surface of the assembly. FIG. 18 is a view showing the upper surface of the assembly. FIG. 19 is a side elevational view showing the assembly. FIG. 20 is a cross sectional view taken along line e-e of FIG. 18. In the assembly according to the fifth aspect of the present invention, like parts as those used in the assembly according to the first aspect of the present invention are identified by the same reference numbers plus 400, and detailed descriptions for the same will be omitted.

In the assembly according to the fifth aspect of the present invention, a load beam 403 of the support includes a pair of flanges 470. The pair of flanges 470 contiguously extend from both edges of an elongated portion 421 to both edges of a base portion 422. Specifically, as exemplified in FIG. 20, the pair of flanges 470 are parts of both edges of the elongated portion 421 bent upwardly into substantially an L-shape in a cross section taken along line e-e that traverses in a width direction of the elongated portion 421 near the trailing end thereof. Likewise in both edges of the base portion 422, parts of both edges thereof are bent upwardly into substantially an L-shape to form the pair of flanges 470. It should be noted that a flexure 404 may not include a backing member 431.

Results of an analysis made using finite element method of major eigen values during loading-on of the assembly (a condition in which the head slider flies above the surface of the magnetic disk medium) will be described. In this analysis, the load beam was 25 μm thick and the flexure was 20 μm thick.

FIG. 21 shows an example of results of an analysis made of five models according to the assembly and a control model. In FIG. 21, each set of data shows the results of the analysis made of the following: specifically, A is that of a control model having no backing members for the flexure, as arranged for convenience sake in the assembly according to the first aspect of the present invention; B is that of the assembly according to the first aspect of the present invention; C is that of the assembly according to the second aspect of the present invention; D is that of the assembly according to the third aspect of the present invention; E is that of the assembly according to the fourth aspect of the present invention; and F is that of the assembly according to the fifth aspect of the present invention.

Referring to FIG. 21, any of the assembly bodies according to the first to fifth aspects of the present invention shown in B through F exhibits eigen values of first torsion mode and first sway mode higher than those of the control model shown in A. It was thus confirmed that each model according to the first to fifth aspect of the present invention is superior to the control model in terms of vibration characteristics.

The assembly according to the fifth aspect of the present invention shown in F, in particular, offers a higher degree of freedom in design for the following reason. Specifically, the eigen value of the first sway mode can be set in the range from 8.3 kHz to 10.3 kHz by adjusting the length of the flange without changing the eigen value of the first torsion mode.

For model B (the assembly according to the first aspect of the present invention), an analysis was made by changing the ratio of wall thickness between the load beam and the flexure. A prominently higher eigen value was obtained as compared with the control model particularly when the wall thickness of the load beam is less than twice as thick as the wall thickness of the flexure (results are not shown in the Figure).

As described in the foregoing, the support does not require any new member for enhancing stiffness of the load beam. Reduction in cost and weight can therefore be achieved with a simple structure.

In the support, the load beam is reinforced by the backing member formed as part of the flexure having a thinner wall than the load beam. Accordingly, reduction in weight as the entire support can be promoted, while enhancing impact resistance.

The assembly including the support and the head slider including the magnetic head causes the head slider to make a relative movement over the surface of the magnetic disk medium. The assembly then magnetizes the magnetic disk medium using the magnetic head, thereby writing information on the magnetic disk medium. The magnetic head of the assembly reads a magnetized pattern on the magnetic disk medium, thereby reading information written on the magnetic disk medium and producing an output of the same.

The magnetic disk drive including the assembly receives an instruction to write information from a host computer and an input of the information to be written. The magnetic disk drive then controls the magnetic head and writes the information inputted thereto in the magnetic disk medium. In accordance with the instruction to read information received from the host computer, the magnetic disk drive moves the magnetic head to a specified location on the magnetic disk medium. Receiving an input of the information read by the magnetic head, the magnetic disk drive produces an output of the information to the host computer.

The magnetic head support according to the present invention is not limited to the preferred embodiment as described in the foregoing. For example, the magnetic head support according to the present invention may be implemented through a stacking system or a caulking system.

In a preferred embodiment of the present invention, the flange may be formed into an L-shape or a U-shape in the cross section thereof. The flange may be formed into any other shape in the cross section thereof.

Furthermore, both the both edges of the elongated portion and both edges of the base portion of the load beam may be a straight line, or may be a curve having a predetermined curvature. The both edges may be a combination of a straight line and a curve.

It is to be understood that the above description is intended to be illustrative and not restrictive. Many embodiments will be apparent to those of skill in the art upon reviewing the above description. The scope of the invention should, therefore, be determined not with reference to the above description, but instead should be determined with reference to the appended claims along with their full scope of equivalents.

What is claimed is:

1. A magnetic head support, comprising:
(a) an arm pivotally supported;
(b) a load beam secured to the arm, the load beam including:
(b-1) a spring portion; and
(b-2) a leading end portion including an elongated portion having a width smaller than an external dimension of the spring portion and having leading end flanges on both edges thereof and a base portion for connecting the elongated portion and the spring portion; and
(c) a flexure secured to the load beam, the flexure including a backing member with which the base portion is backed.

2. The magnetic head support according to claim 1, wherein the backing member is formed to have a width larger than the width of the elongated portion.

3. The magnetic head support according to claim 1, further comprising:
reinforcement flanges formed to extend over an area from the elongated portion to the base portion at a position, in which a part of the reinforcement flanges overlaps the leading end flanges in a width direction of the load beam.

4. The magnetic head support according to claim 3, wherein the reinforcement flanges are formed on the load beam.

5. The magnetic head support according to claim 3, wherein the reinforcement flanges are formed on the flexure.

6. The magnetic head support according to claim 3, wherein the reinforcement flanges are formed near a centerline in a longitudinal direction of the leading end portion of the load beam.

7. The magnetic head support according to claim 6, further comprising a ceiling surface connecting upward to side surfaces of the reinforcement flanges.

8. The magnetic head support according to claim 3, wherein the reinforcement flanges are formed to sandwich the leading end flanges formed on both edges of the elongated portion.

9. The magnetic head support according to claim 8, wherein the reinforcement flanges are formed into substantially an L-shaped in which each of both edges of the backing member is upwardly bent.

10. The magnetic head support according to claim 3, wherein the reinforcement flanges contiguously extend from both edges of the elongated portion to both edges of the base portion.

11. A magnetic head assembly, comprising:
the magnetic head support according to claim 1; and
a head slider including a magnetic head.

12. A magnetic disk drive, comprising:
the magnetic head assembly according to claim 1.

13. A magnetic head support, comprising:
(a) an arm pivotally supported;
(b) a load beam secured to the arm, the load beam including:
(b-1) a spring portion; and
(b-2) a leading end portion including an elongated portion having a width smaller than an external dimension of the spring portion and having leading end flanges on both edges thereof and a base portion for connecting the elongated portion and the spring portion;
(c) a flexure secured to the load beam; and
(d) reinforcement flanges formed on the load beam of the flexure of both the load beam and the flexure to extend over an area from the elongated portion to the base portion at a position, in which a part of the reinforcement flanges overlaps the leading end flanges in a width direction of the load beam.

14. The magnetic head support according to claim 13, wherein the reinforcement flanges are formed near a centerline in a longitudinal direction of the leading end portion of the load beam.

15. The magnetic head support according to claim 14, further comprising a ceiling surface connecting upward to side surfaces of the reinforcement flanges.

16. The magnetic head support according to claim 13, wherein the reinforcement flanges contiguously extend from both edges of the elongated portion to both edges of the base portion.

17. A magnetic head support, comprising:
(a) an arm pivotally supported; and
(b) a load beam secured to the arm, the load beam including:
(b-1) a spring portion; and
(b-2) a leading end portion including an elongated portion having a width smaller than an external dimension of the spring portion and having leading end flanges on both edges thereof and a base portion for connecting the elongated portion and the spring portion, and flanges formed from both edges of the elongated portion to both edges of the base portion.

18. The magnetic head support according to claim 17, wherein the reinforcement flanges are formed near a centerline in a longitudinal direction of the leading end portion of the load beam.

19. The magnetic head support according to claim 18, further comprising a ceiling surface connecting upward to side surfaces of the reinforcement flanges.

20. The magnetic head support according to claim 17, wherein the reinforcement flanges contiguously extend from both edges of the elongated portion to both edges of the base portion.
